(19) United States
(12) Patent Application Publication
(10) Pub. No.: US 2011/0267462 A1
(43) Pub. Date: Nov. 3, 2011

(54) VERSATILE REMOTE VIDEO MONITORING THROUGH THE INTERNET

(76) Inventors: Fred Cheng, Los Altos Hills, CA (US); Herman Yau, Palo Alto, CA (US)

(21) Appl. No.: 12/770,007

(22) Filed: Apr. 29, 2010

(51) Int. Cl. H04N 7/18; H04W 4/00

(52) U.S. Cl. 348/143; 455/422.1; 348/E07.085

(57) ABSTRACT

A communication device for monitoring an infant remotely has a controller and a memory. The communication device also has a transmitter, a receiver, a display screen, and a speaker. The receiver receives data associated with the infant. The data is adapted for display on the display screen and is adapted for outputting audio via the speaker. The controller controls the transmitter for transmitting the data along at least one communication path of a plurality of communication paths to a remote destination.

### FIELD OF THE INVENTION

The present disclosure is directed to a system for the capture of surveillance data and the delivery of the surveillance data to a portable video device for display on the portable video device. The data is also routed from the portable video device along a communication path to a remote destination for display on a second device.

### BACKGROUND OF THE RELATED ART

Prior art surveillance applications are known in the art. The surveillance applications include a video camera connected to a video recorder and a monitor. Generally, the video recorder has a memory and is operatively connected to the video camera close by. When motion is detected inside the predetermined area, video capture can be activated. Digital or analog video data can then be recorded on to the local recorder.

Surveillance video cameras often are used for monitor an infant. The surveillance video camera may be used in a remote manner. The surveillance video camera may record video associated with the infant sleeping and capture audio associated with the infant's voice. Generally, the video and voice signals are sent wirelessly through an analog modulation scheme to the portable video monitor. The video and voice signals will only be displayed and heard through a video monitor that is placed a short distance away from the infant.

In another embodiment, the prior art may use a personal computer to transmit the captured video and audio to another location. In this embodiment, the digital surveillance video camera captures video and audio and then transmits the video and the audio to a personal computer. The personal computer then receives the signals and delivers the signals to a memory or to another location via an Internet connection. However, this configuration is limiting and costly and requires complexity in use and installation. Moreover, a mother or father desires to continuously view the data associated with the infant without having to consult a monitor or without having to log on to a personal computer from various different locations as the caretaker travels from location to location in the home.

The prior art does not allow a user to capture video and audio associated with the infant and then continuously view video and audio data on a portable device and then route the video and audio data to a remote destination for inspection along a plurality of different communication paths.

### SUMMARY OF THE INVENTION

According to a first aspect of the present disclosure, there is provided a method of monitoring an infant remotely. The method comprises capturing data associated with the infant comprising video and audio and wirelessly transmitting the data to a portable device to output the data for inspection on the portable device. The method also comprises that the portable device transmits the data to a second destination to output the data at the second destination.

In yet another aspect of the present disclosure there is provided a communication device for monitoring an infant remotely. The communication device has a controller and a memory. The communication device also has a transmitter, a receiver, a display screen, a microphone and a speaker. The receiver receives data associated with the infant. The data is adapted for display on the display screen and is adapted for outputting audio via the speaker. The controller controls the transmitter for transmitting the data along at least one communication path of a plurality of communication paths to a remote destination.

In another embodiment of the present disclosure, there is provided a portable video monitor for remote inspection of video and audio surveillance data. The portable video monitor comprises a camera for capturing video images and audio data. The portable video monitor has at least one device that directs the captured video images and audio data to (i) a portable device and to (ii) a computing device associated with a remote destination via at least one communication path of a plurality of communication paths.

According to yet another embodiment of the present disclosure there is provided a method for capturing video and audio surveillance data of an infant. The method comprises capturing video images and audio data. The method also includes routing the captured video images and audio data to (i) a portable device at a first mobile location for viewing the video and (ii) a second computing device at a second remote destination.

According to yet another embodiment of the present disclosure there is provided a device comprising a receiver for receiving data associated with captured video images and audio data. The device also has a display for displaying the data and an optional speaker for outputting audio data. The device further has a transmitter to transmit data to a computing device associated with a remote destination via at least one communication path of a plurality of communication paths. The transmitter is in a dongle operatively connected to the display.

According to yet a further embodiment of the present disclosure there is provided a recordable computer medium. The recordable computer medium comprises program instructions for authenticating a first user and once authenticated program instructions for allowing the first user access to a software platform. The recordable computer medium also has program instructions for receiving captured video and audio data displayed on a portable video monitor associated with a second user and program instructions for displaying the captured audio and video data to a display associated with the first user. The recordable computer medium further has program instructions for permitting the first user or the second user to control a surveillance camera associated with the captured video and audio data.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout different views. The drawings are not meant to limit the invention to particular mechanisms for carrying out the invention in practice, but rather, the drawings are illustrative of certain ways of performing the invention. Others will be readily apparent to those skilled in the art.

FIG. 1 shows a system diagram according to the present disclosure having a portable video unit so a first user can monitor an infant and that transmits video and audio data to a second user to assist with monitoring the infant;

FIG. 2 shows a schematic of the portable video monitor of FIG. 1 having a number of components; and

FIG. 3 shows a number of method steps for a method of capturing video images and audio associated with an infant and displaying the data on a portable video monitor unit and then communicating the data to a second location over a number of different communication paths.

### DETAILED DESCRIPTION OF THE PREFERRED EMBODIMENTS

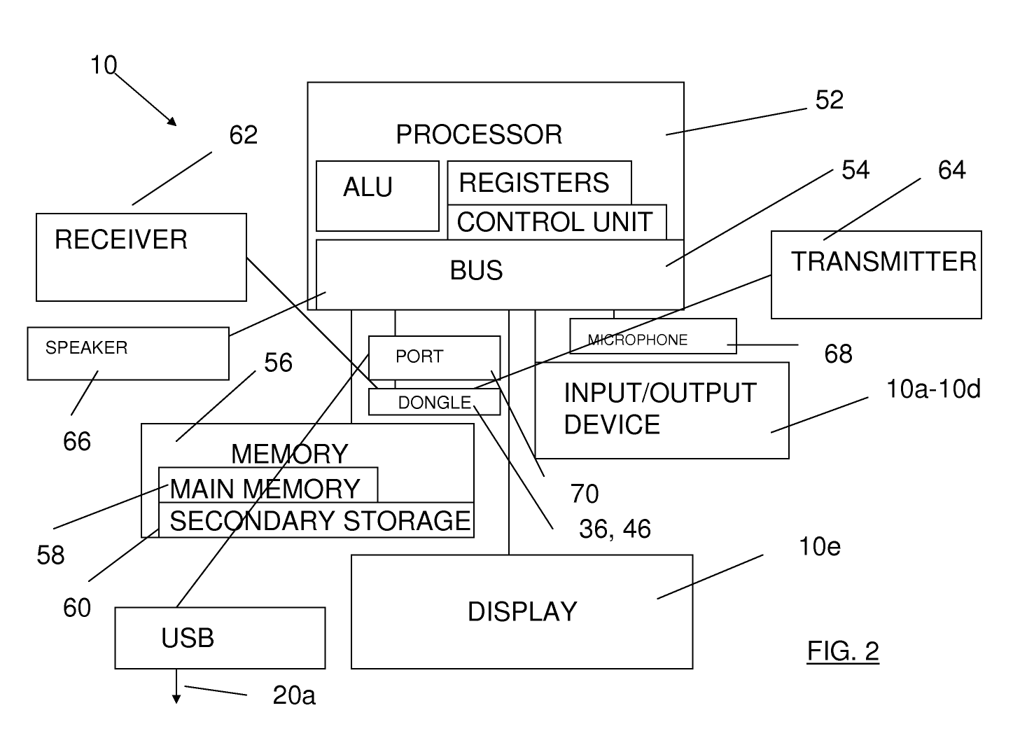

The present disclosure preferably is directed to a portable video monitor 10. The portable video monitor 10 is for inspection of surveillance data or the inspection of captured video and audio of a surveillance camera monitoring an infant 12 in a remote and continuous manner. The portable video monitor 10 does not require a personal computer for operation and is lightweight. The portable video monitor 10 can allow a parent to carry on daily tasks while a baby 12 is sleeping while the parent continuously monitors the video and audio associated with the baby 12. The portable video monitor 10 allows the user to monitor in a mobile manner without having to resort to inspecting a personal computer or without having to resort to consulting a heavy monitor. The portable video monitor 10 may optionally include a microphone 68 shown in FIG. 2 to wirelessly transmit an audio signal from the portable video monitor 10 to the infant 12 from a remote location. Alternatively instead of monitoring an infant 12, the system 5 may be used to monitor relatively older children, children requiring care, or any other video target or protected space or area known in the art.

Cameras 16a-16d may be analog cameras. The portable video monitor 10 will digitize the analog voice and video data before sending the data to the Internet. In other words, data sent to Internet will be in digital form but the data may be captured by analog cameras 16a-16d. The portable video monitor 10 in this manner acts as an analog to digital format conversion agent. This feature is advantageous and will allow use of existing analog camera components with the existing installation. Therefore, the portable video monitor 10 can be used with all analog or digital cameras to easily send the video and voice data through Internet for remote monitoring purpose.

The portable video monitor 10 may optionally output a control signal wirelessly to control the surveillance camera 16a to pan, tilt, or zoom to the monitor the infant 12 from a remote location. The portable video monitor 10 can weigh as little as 135 grams, however may also be connected to a band and worn around the wrist of the wearer. Various size configurations are possible and the above weight forms no limitations to the present disclosure. Preferably, the portable video monitor 10 allows at least two or more people to monitor the infant 12 from different locations in a shared arrangement in real time.

Additionally, the portable video monitor 10 can output data to a software platform 28a along a first path 20a, a second path 20b or a third path 20c to a remote destination 14. In this manner, a remote user, such as, for example, a grandparent, spouse, or uncle or other remote user may also assist with monitoring the infant 12 from a remote location 14 in real time. For example, three individuals may simultaneously monitor video and audio associated with the infant 12 from three different locations in a continuous and easy manner for redundant protection. For example, a mother, a father, nanny or caregiver may use the portable video monitor 10 at home to monitor the infant 12 close by while doing house-hold chores.

The (i) wireless cameras 16a-16d, the (ii) portable video monitor 10 and other (iii) monitoring equipment 34 and 44 used by remote users each also has both at least one speaker and at least one microphone. These audio components allow a two way audio communication between the wireless camera 16a-16d and monitoring devices 10, 34, 44. So the remote monitoring user using the portable device or personal computer 34, 44 can speak and transmit audio data, video data or messages back to the monitored infant or video target in a real time basis if it is so desired. This is advantageous and allows for a more close inspection of the infant.

Furthermore, the system 5 also allows control data be sent from remote units 34 and 44 to at least one of or all of the wireless cameras 16a-16d. In this manner, the camera 16a-16d can be controlled by the pan, tilt and zoom commands initiated by the remote monitoring user using either a portable device 34 or a computing device 44 to view the specific chosen image. The control data can be from the portable video monitoring unit 10 as well as other authorized remote monitoring equipment 34 and 44 or from another user accessing a website in a cloud computing arrangement.

The portable video monitor 10 can be a handheld liquid crystal display video monitor, a mobile communication device (cell phone), a personal computer, a netbook, a notebook computer, a tablet personal computer (such as an iPAD® device manufactured by Apple®), a personal digital assistant or similar equipment that has at least a wireless transceiver to communicate with the wireless camera 16a-16d and a communication port to link to the Internet. The transceivers can be built inside the device 10 or may be added an add-on wireless communication dongle. Dongle can be then connected to the portable video monitor 10. Various computing configurations are possible and within the scope of the present disclosure.

The portable video monitor 10 may also allow the caregiver to traverse the entire home while inspecting (watching) video and listening to audio signals associated with the infant 12. At the same time, via at least one communication path 20a-20c, or by using a software program application generally shown as reference numeral 28a, a spouse and/or a grandparent at the remote location 14 may simultaneously inspect the video and audio signals associated with the infant 12. If an emergency arises, the individual at the remote location 14 may view the video and listen to the audio and deliver a control signal to a surveillance camera 16a-16d, deliver an audio or video message or call the caregiver at the surveillance location (using a second device) to check on the infant 12. The present disclosure allows the caregiver to have extra support in caring for the child 12 from individuals that may be located in a different city or at work miles away (or even in a mobile location such as while traveling on the train). Further, a parent at the remote location 14 may conduct a surprise inspection on the nanny at the home in real time to ensure services are adequate. If inadequate, the parent may call the nanny to lodge a complaint or take corrective action. It should be appreciated that in all instances the caregiver associated with the portable device 10 has full responsibility for the child 12 and the system 5 is not intended to replace an individual local caregiver of the infant 12 and the infant 12 should remain supervised at all times.

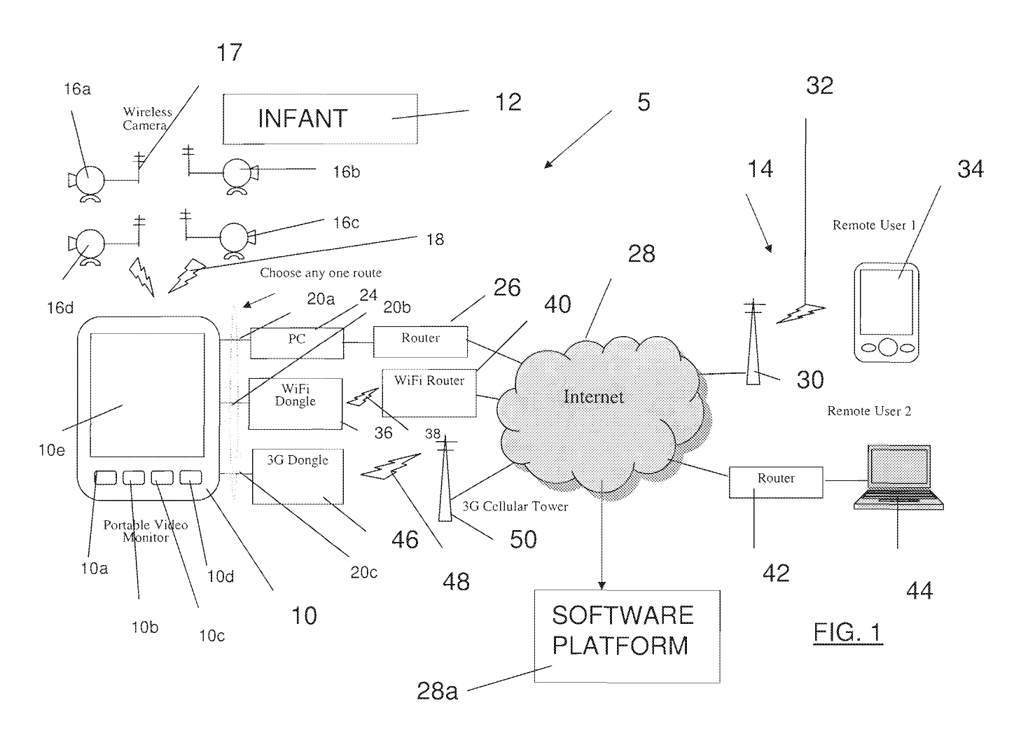

Turning now to FIG. 1, there is shown a system 5 for capturing surveillance information of an infant 12. The system 5 displays the video and outputs audio data on a portable video monitor 10 that can be handheld and also routes the data to a remote location 14 along a number of communication paths 20a, 20b, 20c. The system 5 includes a first video camera 16a, a second video camera 16b, a third video camera 16c and a digital video camera 16d. Each of the cameras 16a-16d preferably includes a RF antenna 17 for transmitting signals and for receiving signals generally shown as reference numeral 18. The first through fourth video cameras 16a, 16b, 16c and 16d are connected to a portable video monitor 10 in a wireless manner. In one embodiment, the portable video monitor 10 may receive signals and communicate signals 18 via a Bluetooth®, Wi-Fi (802.11b/g), or via Bluetooth® 2.1 protocol with Enhanced Data Rate wireless technology.

Less preferably, at least one of the first through fourth video cameras 16a-16d may be connected by a wired manner, such as, for example, by a coaxial cable, however, it is preferred that the portable video monitor 10 is wireless and mobile. In an alternative embodiment, the first through fourth video cameras 16a-16d may be connected to a base station (not shown) and the base station may wirelessly communicate signals to the portable video monitor 10.

The first through fourth video cameras 16a through 16d are preferably cameras that take video or still photographs, or both, by recording images via an electronic image sensor. The first through fourth video cameras 16a through 16d may also include a night vision feature to record data of a sleeping infant and may include infrared light emitting diodes with auto activation and with a video resolution of about 640×480. The first through fourth video cameras 16a through 16d can be closed-circuit television cameras, generally used for security, surveillance, and/or monitoring purposes. The first through fourth video cameras 16a through 16d can be small, easily hidden, and able to operate unattended for monitoring a predetermined area for long periods of time. For example, the first through fourth video cameras 16a through 16d can be webcams operable for use as a closed circuit television camera. The first through fourth video cameras 16a through 16d each may convert a signal from the electronic image sensor directly to a digital output and can incorporate a circuit to directly interface with a specific protocol into the portable video monitor 10.

Alternatively instead of the portable video monitor 10, the first through fourth video cameras 16a through 16d can interface and output a signal to a different device. For example, the device 10 may be Smart Phone, such as a BLACKBERRY® communication device or mobile phone, an APPLE® I-PHONE®, APPLE® I-POD®, a mobile phone, an e-Book Reader, or other device such as a computer or communications hardware, a net-book, a desktop, or a predetermined models of laptop computers. It should be appreciated that the present disclosure may be embodied as program instructions that can be loaded into a computer device or Smart Phone.

For example, the method of the present disclosure may be operable as an application loaded on an APPLE® I-PHONE® or APPLE® I-POD®, BLACKBERRY® communication device, a mobile phone, a GOOGLE® NEXUS ONE® phone, an AMAZON® KINDLE® E-READER®, or any other communication device or computer known in the art. The first through fourth video cameras 16a through 16d may further communicate an output through an analog-to-digital converter in order to store the output or send the output to a wider network. The digital video may be H.261, H.263, H.264, JPEG, MJPEG, MPEG or any other digital video formats known in the art.

The first path 20a is from at least one of a number of video cameras 16a, 16b, 16c, and 16d to the portable video monitor 10 and then to a personal computer 24. The personal computer 24 is operatively connected to a network router 26, which is connected to the Internet 28. The first path 20a continues from the Internet 28 to a telecommunication base station 30, where the data is transmitted in a wireless manner along path 32 to a remote destination 14 and to a remote computing device or communication device 34.

The portable video monitor 10 is connected along the first path 20a, the second path 20b and the third path 20c to a software platform 28a accessible form the Internet 28. The software platform preferably can be a SEEDONK® Video Management platform 28a, which is incorporated by reference in its entirety. The software platform 28a can be a video monitoring and a video sharing application and is a consumer platform for viewing, managing and sharing cameras over the Internet. The software platform 28a is operable on a personal computer 44, a mobile communication device 34, a network appliance, or is operable on a server. The computer running the first software platform 28a may be a cloud computing configuration or may include a memory, a processor, a bus, a display, a user interface collectively shown as reference numeral 44 and network router 42 as shown in FIG. 1. The computing device 34, 44 shown in FIG. 1 forms no limitations to the present disclosure and is merely illustrative of one non-limiting embodiment. For example, using the software platform 28a, the user can be authenticated for access. Thereafter, the user may then view the output of the digital video camera 16a-16d and see and hear the infant 12. The user may then also use the prompts associated with the software platform 28a to control the video camera 16a-16d to pan, tilt, zoom or perform any other control functions associated with the digital cameras 16a-16d and also send messages to other users.

The second communication path 20b is from the video camera 16a, 16b, 16c and 16d to the portable video monitor 10 to a dongle 36 and to the Internet 28. Dongle 36 is preferably a Wi-Fi dongle 36. A dongle 36 is a small piece of hardware that connects to portable video monitor 10 in a wireless manner so the portable video monitor 10 may remain mobile yet remain connected to one or more components of the system 5. Dongle 36 acts as a broadband wireless adaptor or in general is a connector that translates one type of port to another. Dongle 36 facilitates the transfer of digital data from one component of the system 5 to the remote destination 14 and to the remote computer 34 or 44.

Dongle 36 is connected to the portable video monitor 10 via path 20b. Dongle 36 enables the connection between the monitor 10 to at least one surveillance camera 16a, 16b, 16c, 16d and to the remote location 14. Data can be communicated in a wireless manner in a specific protocol to be received by a wireless router 40 from the dongle 36. Wireless router 40 is connected to the Internet 28 and facilitates communication of the data to the remote destination 14 and to the computers 34 and 44. The dongle 36 is operatively connected to a Wi-Fi router 40 in a wireless manner along reference numeral 38. The Wi-Fi router 40 is connected to the Internet 28 and to a remote destination 14. In one embodiment, a second network router 42 is connected to the Internet 28 in a different location 14 and is operatively connected to a second personal computer 44. Second network router 42 is located at the remote destination 14 where a second user may access the captured video and audio data of the infant 12 by the surveillance cameras 16a-16d.

The third path 20c can be communicated via a wireless method. For example, the third communication path 20c can be communicated from at least one of the surveillance cameras 16a-16d to the portable video monitor 10 and to a dongle 46. The dongle 46 wirelessly communicates data along line 48 to a telecommunication base station 50 over a 3G format, which is connected to the Internet 28. Base station 50 preferably receives the signal from the video cameras 16a through 16d and communicates the signal to the Internet 28. The base station 50 is preferably a gateway between a wired network and the wireless network.

3G refers to the International Mobile Telecommunications-2000 (IMT-2000) or the 3rd Generation standards for mobile telecommunications defined by the International Telecommunication Union, which is incorporated by reference in its entirety. 3G preferably includes at least one of GSM, EDGE, UMTS, and CDMA 2000 as well as Time Division Synchronous Code Division Multiple Access (“TD-SCDMA”), Digital Enhanced Cordless Telecommunications (“DECT”) and Wi-MAX®. 3G may further include a wide-area wireless voice telephone, video calls, and wireless data, all in a mobile environment that allows simultaneous use of speech and data services and higher data rates of up to about 14.0 Mbit/s on the downlink and about 5.8 Mbit/s on the uplink.

A 3G dongle 46 is a broadband wireless adaptor or a connector that translates one type of port to another. 3G dongle 46 facilitates the transfer of digital data from one component of the system 5 to the remote computer 34 or 44 over a wireless telecommunication network via a telecommunication base station 50. Dongle 46 is operatively connected to at least one video camera 16a-16d via the portable video monitor 10. Data can be communicated along path 20c and then through 3G dongle 46 in a wireless manner in a specific protocol to be received by a nearby base station 50 and then to its central station (not shown), which is connected to the Internet 28. Data is then communicated to the remote destination 14 and the remote computer 34 or 44 so the particular user at the second location 14 may view the video and listen to the audio of the infant 12. It should be appreciated that the transfer of digital data is achieved in packets over a specific predetermined frequency. Wireless telecommunications network 50 is generally implemented with some type of remote information transmission system that uses electromagnetic waves, such as radio waves, for the carrier. The implementation usually takes place at the physical level or “layer” of the network. Alternatively, in a further embodiment, the portable video monitor 10 may communicate with the remote destination 14 and the associated remote computing device 34 and 44 with a different standard, such as, for example, the IEEE 802.16 standard, which is incorporated by reference in its entirety.

Thereafter, the data can be communicated to the remote destination 14 from the Internet 28 as previously discussed above or via a different manner such as for example, with a Network router, a Wi-Fi dongle, a Wi-Fi Router, Wi-Max, Cellular Phone Network or a wireless protocol.

Preferably, the portable video monitor 10 may control the specific video camera 16a-16d to initiate the display of the video data of the infant 12 or to magnify an image of the infant 12 or to record the data. Moreover, the portable video monitor 10 may also send a control signal to specific video camera 16a-16d to pan, tilt, zoom or send an audio signal from the parent or the caregiver to the infant 14. Preferably, the portable video monitor 10 includes a plurality of inputs 10a, 10b, 10c and 10d and a display screen 10e, which may be various resolution known in the art, such as 360p, 480p, 720p, 1080p or the like. Various display 10e configurations are possible and within the scope of the present disclosure. In one embodiment, the display 10e may have a 480-by-320-pixel resolution at 163 ppi. The inputs 10a-10d can be mechanical switches, a touch screen interface, trackball, mouse, a button, a joystick, or any other input known in the art. Furthermore, the inputs 10a-10d are not limited to a physical input, and the entire portable video monitor 10 may include an accelerometer, which may serve as an input device. Various configurations are possible and within the scope of the present disclosure.

The portable video monitor 10 may further perform a video processing operation on the data prior to sending the data along the first, the second or the third paths 20a-20c. For example, the portable video monitor 10 may compress the data prior to sending the data along the first through third paths 20a-20c. The portable video monitor 10 may remove frames from the images that are redundant prior to transmitting the data along the specific paths 20a-20c. Various data rate configurations are possible and within the scope of the present disclosure. It should be appreciated that the video compression may even permit the transfer of video over a relatively small bandwidth. For example, the portable video monitor 10 may embed or incorporate data into the captured video image. The embed data can be text such as the day, hour, minute, second, camera identification information (Camera 1, Camera 2, etc.), alarm, object presence, event data, or any other identification data known in the art. The portable video monitor 10 may further embed or incorporate metadata into the captured video image. For example, if the infant starts to cry, or starts to yell out loud in a predetermined volume level the portable video monitor 10 may embed, “baby crying,” the temperature in the room, and the date and time into the lower right hand corner of the video image. In this manner, the user at the second remote location 14 may be alerted when reviewing.

Preferably, the data is communicated to the portable video monitor display 10e and to the remote location 14, when the users operating the remote computers 34 and 44 are authenticated using the software platform 28a. Once authenticated, the data may be communicated to the computer 34 or 44 associated with the remote location 14. The path 20a, 20b and 20c may take various forms to communicate the data to the remote computer 34, 44 or a third computing device. For example, the portable video monitor 10 may be connected along path 20a to a Network Router 26 or the second path 20b to Wi-Fi router 40, or the third path 20c to the 3G base station 50 which communicates the digital information across the Internet 28 to the remote location 14. It should be appreciated that in one embodiment of the present disclosure the data can take at least two communication paths of the three communication paths 20a-20c simultaneously or at least three communication paths for faster data transfer.

Turning now to FIG. 2, there is shown a schematic view of the interior components of the portable video monitor 10 according to the present disclosure. The portable video monitor 10 preferably includes a processor 52 that includes an arithmetic logic unit, registers and a control circuit as is known in the art. The arithmetic logic unit (ALU) is a digital circuit that performs arithmetic and logical operations and is a fundamental building block of the central processing unit (CPU) of a computer. For example, the portable video monitor 10 may include a 620 MHz or higher digital signal processor from INTEL® CORPORATION, or AMD® CORPORATION or the like and suitable for portable applications. In one embodiment, the processor 52 may be a 620 MHz ARM chip. Alternatively, the processor 52 may be a multiple core or quad core processor as is known in the art.

The portable video monitor 10 further includes a bus 54, or an interconnection mechanism such as a peripheral connection bus or circuitry which couples to an input device 10a-10d. The portable video monitor 10 also includes a storage device or memory 56 (such as a computer disk for a main memory 58 and secondary storage 60) and an output device such as display screen 10e. The portable video monitor 10 also has a transmitter and receiver 62 and 64 or transceiver for connecting to the Internet 28 as discussed above for FIG. 1, which are located in the dongle 36 or dongle 46. In an alternative less preferable embodiment, the portable video monitor 10 may include a separate transmitter 64 and receiver 62 or transceiver operatively connected to the bus 54 instead of dongle 36, 46. Preferably, the bus 54 may include a port 70 whereby the dongle 36 or 46 may connect and the dongle includes the transmitter 64 and receiver 62 or transceiver.

Various configurations are possible and within the scope of the present disclosure and the present configuration is merely illustrative of one embodiment of the present disclosure. The portable video unit 10 may be formed with no transmitter 64 or receiver 62 and with at least one dongle 36 and 46. In another embodiment, the unit 10 may include two dongles 36 and 46. In a further embodiment, the unit 10 may include a USB port for a network connection to a personal computer 24 as shown in FIG. 1. The portable video monitor 10 optionally includes a microphone 68. Microphone 68 is for capturing audio from the user or caregiver and transmitting the audio to the infant 12 via one or more speakers near the infant 12, which may be integral or separated from a camera 16a-16d. The portable video monitor 10 includes a speaker 66 for playing audio captured from a microphone (not shown) located close by to the infant 12. Preferably, the infant microphone (not shown) is integrated into one or more of the surveillance cameras 16a-16d.

In operation, the processor 52 receives data from at least one video camera 16a-16d from the receiver 62 via the dongle 36 and 46 and displays the video on the display 10e and outputs the audio data on the speaker 66. In this manner, the operator of the portable video unit 10 can be in another room of the home, educational setting, or performing chores while still monitoring the infant closely 12. The operator may control the input device 10a-10d to pan, tilt, zoom or otherwise control at least one camera 16a-16d.

The operator may further record an audio signal using the microphone 68. The processor 52 may convert the audio signal to a digital signal. Processor 52 then transmits the digital signal back to the infant for playback using a speaker associated with the digital camera 16a-16d or located close by (not shown). Additionally, the processor 52 may record the data on the memory 56 for review later. Memory 56 may be less than 1 Gigabyte or more than 5 Gigabytes and may record a predetermined amount of video and audio data. Further processor 52 may perform one or more processing operations on the video and audio data. These may include as embedding data or metadata and compressing the data by using a frame removal operation. Processor 52 may then output a control signal to transmitter 64 to then transmit the data along the first, the second or the third paths 20a-20c (via the transmitter 64 or via the network connection 20a or via the dongle 36 or 46 to the Internet 28).

A second user may review the video data and audio data at the second location 14 once authenticated using the software platform 28a. Second user may review by using second computer 34, 44, or by using a third computing device (not shown) or by accessing the software platform 28a in a cloud computing configuration. Furthermore, a second user may communicate with the infant 12. The second user can send an audio signal or control signal from the remote computer 34, 44 to a base station 30 or via router 42 to the Internet 28 shown in FIG. 1. Audio signal can be output using a speaker (not shown) near the infant 12 or that is integrated with the digital cameras 16a-16d located near to the infant 12. Audio signal may also be output at the speaker 66 on the unit 10 shown in FIG. 2.

Control signal can be transmit from the remote computer 34, 44 to the base station 30 or via router 42 to the Internet 28. Control signal from the second user (location 14) can be (i) to start or initiate a recording of video or audio, (ii) to change resolution of the captured image, (iii) to control at least one camera 16a-16d to pan, tilt, or zoom a lens of at least one digital camera 16a-16d or (iv) any other control function known in the art. Furthermore, the user associated at the second location 14 can communicate with the portable video monitor 10 and can output text, voice messages, signals, or video to unit 10 or the display 10e. Furthermore, the second user associated at the second location 14 can initiate an alarm or send an urgent message. Various media may be exchanged and is within the scope of the present disclosure. Finally, the portable video monitor 10 may include a lithium ion rechargeable battery for powering the components of the monitor 10.

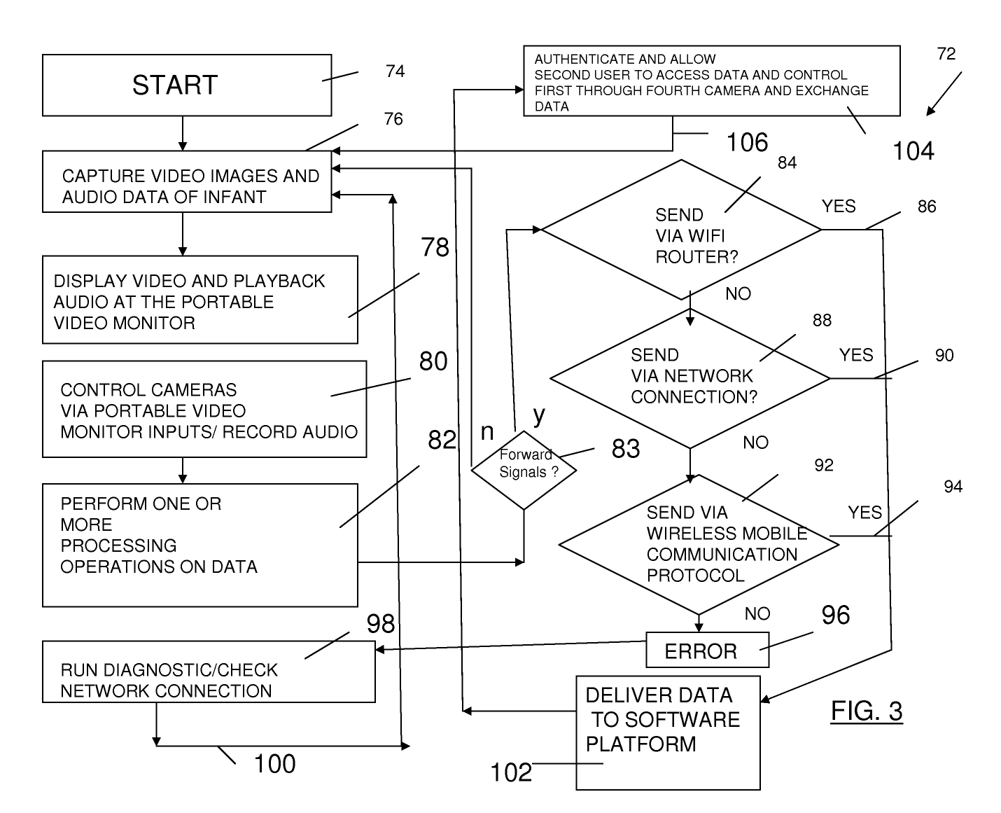

Turning now to FIG. 3, there is shown a method according to the present disclosure generally represented as reference numeral 72. It should be also appreciated that the method steps are not limited to the hierarchal order shown and some steps can be performed before others and some steps can be performed simultaneously. Various configurations of the present method are possible and within the scope of the present disclosure.

The method 72 commences at step 74 and passes to step 76 where digital video images and audio are recorded. Preferably, data is transmitted to the portable video unit 10 along line 18 of FIG. 1. At step 78, the video is displayed on the portable video unit 10 and the audio of the infant is output so the user can remotely view and monitor the baby 12. At step 80, the portable video unit 10 may control the one or more cameras 16a-16d via inputs 10a-10d, control the pan, tilt, zoom function, adjust audio using the inputs 10a-10d and also record video and audio to the memory 56.

At step 82, the method 72 may perform one or more operations on the data received from the cameras 16a-16d. This can be a basic compression operation plus a basic processing operation. For example, metadata, data may be embedded in the video signal or frames may be removed so the data can be transmitted in a rapid manner. For example at step 82, data or metadata can be embedded into the digital data associated with the video and audio. For example, the data may undergo a known compression or processing algorithm.

Control then passes to step 83 where a decision is determined should the video and voice signals be forwarded to software platform 28a or not. If the decision is in the negative, the video and voice signal will only be available on the portable video monitor 10 and control of the method passes back to step 76 to continue capturing the data of the infant using the personal video unit 10. If the decision is in the affirmative at step 83, then control passes to step 84. At step 84, it is determined whether the data is to be sent to the Internet 28 via one of the three possible routes, namely (i) a personal computing device 24 connected to the unit 10 and a router 26 or (ii) a Wi-Fi dongle 36 connected to the unit 10 and a Wi-Fi router along path 20b or (iii) a wireless mobile device such as the 3G dongle 46 and route 48 to mobile communication tower 50 or (iv) other wireless mobile communication method. It should be appreciated that the hierarchal arrangement shown forms no limitation to the present disclosure, and the method encompasses a different order than the one shown in FIG. 3 as many steps may be arranged in a different order and/or performed at the same time. If appropriate to be delivered by the Wi-Fi router 40 shown in FIG. 1 then control passes along line 86 to step 102 where the data is transmitted to the software platform 28a via the Internet 28.

If not appropriate to be delivered by the Wi-Fi router 40 at step 84 then control passes to step 88. At step 88, it is determined whether the data is to be sent to the software platform 28a via a network connection or via a personal computer 24 and a network router 26 along the first path 20a as shown in FIG. 1. If appropriate to be delivered by the network connection then control passes along line 90 to step 102 where the data is transmitted to the software platform 28a via the Internet 28. If not appropriate to be delivered by the network connection at step 88, then control passes to step 92.

At step 92, it is determined whether the data is to be sent to the software platform 28a via mobile communication protocol via the 3G dongle 46 to the mobile communication tower 50 to the Internet 28 along the third path 20c. If appropriate then control passes along line 94 to step 102 where the data is transmitted to the software platform 28a. If not appropriate then control passes to step 96. At step 96, the method 72 assumes that there is a network connection error and control passes to step 98 to run a diagnostic or to provide a message to the user to “check an Internet connection” which can be output to the display 10e shown in FIG. 1. Thereafter, control passes along line 100 to step 76 to continue capturing video and audio images.

Once data is communicated to the software platform 28a at step 102, then control passes to step 104. At step 104, the user at the second location 14 is authenticated and is permitted access to the video and audio data of the infant 12 for surveillance purposes. Also at step 104, the user at the location 14 is permitted to control the first through fourth cameras 16a-16d and is permitted to exchange data with the individual operating the personal video unit 10 and other individuals. Further, the user at the location 14 is permitted to transmit audio to be heard at a speaker located in close proximity to the infant to soothe the infant 12. For example, a parent at work a distance away from the infant 12 may speak to the infant 12 or may speak to the user associated with the video unit 10 in the event the infant is crying.

At step 104, a user may access the data using a Personal Digital Assistant, an APPLE ® I-PHONE® or APPLE® I-POD®, a tablet computer, an APPLE® I-PAD®, a BLACKBERRY® communication device, a MOTOROLA® DROID® phone, a GOOGLE®/HTC® NEXUS ONE® phone, a laptop, a net-book, a desktop or other Internet communication device to login to the software platform 28a and to access the video on a real-time basis. Thereafter, control passes along line 106 to step 76 to continue capturing video and audio images of the infant 12.

Generally, in operation, the computer system operable with that method shown in FIGS. 1-3 is controlled by an operating system. Typical examples of operating systems are MS-DOS, Windows95, 98, 2000, XP, Vista and Windows 7 from Microsoft Corporation, or Solaris and SunOS from Sun Microsystems, Inc., UNIX based operating systems, LINUX based operating systems, or the Apple OSX from Apple Corporation. As the computer system operates, input such as input search data, database record data, programs and commands, received from users or other processing systems, are stored on storage device. Certain commands cause the processor to retrieve and execute the stored programs. The programs executing on the processor may obtain more data from the same or a different input device, such as a network connection. The programs may also access data in a database for example, and commands and other input data may cause the processor to index, search and perform other operations on the database in relation to other input data. Data may be generated which is sent to the output device for display to the user or for transmission to another computer system or device. Typical examples of the computer system are personal computers and workstations, hand-held computers, dedicated computers designed for a specific purpose, and large main frame computers suited for use many users. The present invention is not limited to being implemented on any specific type of computer system or data processing device.

It is noted that the present invention may also be implemented in hardware or circuitry which embodies the logic and processing disclosed herein, or alternatively, the present invention may be implemented in software in the form of a computer program stored on a computer readable medium such as a storage device. In the later case, the present invention in the form of computer program logic and executable instructions is read and executed by the processor and instructs the computer system to perform the functionality disclosed as the invention herein. If the present invention is embodied as a computer program, the computer program logic is not limited to being implemented in any specific programming language. For example, commonly used programming languages such as C, C++, JAVA as well as others may be used to implement the logic and functionality of the present invention. Furthermore, the subject matter of the present invention is not limited to currently existing computer processing devices or programming languages, but rather, is meant to be able to be implemented in many different types of environments in both hardware and software.

Furthermore, combinations of embodiments of the invention may be divided into specific functions and implemented on different individual computer processing devices and systems which may be interconnected to communicate and interact with each other. Dividing up the functionality of the invention between several different computers is meant to be covered within the scope of the invention.

While this invention has been particularly shown and described with references to a preferred embodiment thereof, it will be understood by those skilled in the art that is made therein without departing from the spirit and scope of the invention as defined by the following claims.

What is claimed is:

1. A method of monitoring an infant remotely comprising:
capturing data associated with the infant, the data comprising at least one of video and audio;
wirelessly transmitting the data to a portable device to output the data for inspection on the portable device; and
the portable device transmitting the data to a second destination to output the data at the second destination.

2. The method of claim 1, further comprising capturing data associated with the infant using a wireless surveillance camera.

3. The method of claim 1, further comprising wireless transmitting the data to a portable video monitor for viewing the video and listening to the audio associated with the infant on the portable video monitor.

4. The method of claim 1, further comprising capturing audio at the portable device and transmitting audio to the infant.

5. The method of claim 1, further comprising transmitting the data to the second destination by at least one of a plurality of communication paths to the second destination.

6. The method of claim 5, further comprising transmitting the data to the second destination by a computing device.

7. The method of claim 6, further comprising transmitting the data to the second destination by the computing device connected to a network router that is connected to the Internet.

8. The method of claim 7, further comprising transmitting the data to the second destination by the computing device connected to the network router that is connected to the Internet, and communicating the data to a second network router to a second computing device.

9. The method of claim 1, further comprising communicating the data to a base station and to a second portable device for viewing the data and listening to the audio on the second portable device.

10. The method of claim 5, further comprising transmitting the data to the second destination wirelessly via a dongle operatively connected to the portable device.

11. The method of claim 10, further comprising transmitting the data via the dongle to a network router in a wireless manner and to the Internet to the second destination.

12. The method of claim 10, further comprising transmitting the data via the dongle to a base station in a wireless manner and to the Internet to the second destination.

13. The method of claim 5, further comprising selecting the communication path to transmit the data to the second destination from the plurality of communication paths.

14. The method of claim 13, further comprising selecting from transmitting the data from at least two communication paths selected from (i) the dongle, (ii) the computer device and (iii) a wireless dongle to the second destination.

15. The method of claim 2, further comprising controlling the wireless surveillance camera from a signal from the portable device.

16. The method of claim 2, further comprising controlling the wireless surveillance camera from a signal from the second destination.

17. The method of claim 1, further comprising recording the data at the portable device.

18. The method of claim 1, further comprising recording the data at the second destination or recording the data at a location defined between (i) a wireless surveillance camera and (ii) the second destination.

19. The method of claim 5, further comprising routing the data along at least one communication path of at least three communication paths from the portable device to the second destination.

20. The method of claim 19, further comprising routing the data along at least two communication paths of at least three communication paths from the portable device to the second destination.

21. The method of claim 20, further comprising routing the data along at least three communication paths from the portable device to the second destination.

22. A communication device for monitoring an infant remotely, the communication device comprising:
a controller and a memory connected to a bus;
a transmitter;
a receiver;
a display screen connected to the bus;
a speaker connected to the bus;
the receiver receiving data associated with the infant, the data adapted for display on the display screen and adapted for outputting audio via the speaker; and
the controller controlling the transmitter for transmitting the data along at least one communication path of a plurality of communication paths to a remote destination.

23. The communication device of claim 22, further comprising a surveillance camera capturing video and audio and transmitting the video and audio to the receiver.

24. The communication device of claim 22, further comprising a plurality of surveillance cameras with each capturing video and audio and each of the plurality of surveillance cameras transmitting the video and audio to the receiver.

25. The communication device of claim 23, wherein the surveillance camera is a pan, tilt, zoom camera.

26. The communication device of claim 23, wherein the surveillance camera captures video and audio, and wherein the surveillance camera transmits the video and audio in a digital signal to the receiver.

27. The communication device of claim 22, further comprising a microphone.

28. The communication device of claim 27, wherein the microphone captures audio at the communication device and transmits the audio to the infant via a signal output from the transmitter.

29. The communication device of claim 22, wherein the memory comprises program instructions for a mobile telephone.

30. The communication device of claim 22, wherein the data is sent along a first communication path, the first communication path being to a computing device to a network router to the Internet and to the remote destination.

31. The communication device of claim 30, wherein the transmitter and receiver are located in a dongle, and wherein the controller controls the transmitter for transmitting the data along a second communication path, the second communication path being from the dongle to a router to the Internet and to the remote destination.

32. The communication device of claim 31, wherein the router is a wireless router.

33. The communication device of claim 31, wherein the controller controls the transmitter for transmitting the data along a third communication path, the third communication path being from the dongle to a base station to the Internet and to the remote destination.

34. The communication device of claim 22, further comprising a computing device associated with the remote destination, the computing device receiving the data for display at the computing device associated with the remote destination.

35. The communication device of claim 34, wherein the computing device associated with the remote destination is a personal computer or a mobile communication device.

36. The communication device of claim 35, wherein the computing device associated with the remote destination delivers a control signal to a surveillance camera recording video and audio of the infant.

37. The communication device of claim 34, wherein the computing device associated with the remote destination receives the data in a wireless manner from a base station, or wherein the computing device associated with the remote destination receives the data in a wired manner from a network router being connected to the Internet.

38. The communication device of claim 22, further comprising a rechargeable power source operatively coupled to at least one component of the communication device, and wherein the communication device is mobile.

39. The communication device of claim 35, further comprising a computing device associated with a third location, wherein the computing device associated with the third location is coupled to the Internet, wherein the computing device associated with the third location communicates a control signal to a surveillance camera recording video and audio data.

40. A portable video monitor for remote inspection of video and audio surveillance data comprising:
a camera for capturing digital video images and audio data; and
at least one device for directing the captured video images and audio data to (i) a portable device and to (ii) a computing device associated with a remote destination via at least one communication path of a plurality of communication paths.

41. The portable video monitor of claim 40, wherein the portable device is a portable video unit, a mobile telephone, a digital audio player, a digital device, a battery powered device comprising a display, or a mobile communication device.

42. A method for capturing video and audio surveillance data of an infant, the method comprising:
capturing data comprising digital video images and audio data; and
routing the captured video images and audio data to (i) a portable device at a first mobile location for viewing the video and (ii) a second computing device at a second remote destination.

43. The method of claim 42, further comprising routing the captured video images and the audio data along at least one of a first communication path, a second communication path or a third communication path;
the first communication path being to a personal computing device to a network router to the Internet and to the second remote destination;
the second communication path being from a dongle operatively connected to the portable device to a wireless router to the Internet and to the second remote destination;
the third communication path being from the dongle operatively connected to the portable device to a base station and to the Internet and to the second remote destination; and
wherein at to the second remote destination the second computing device receives the data in a wired manner from a second router and from the Internet; or
wherein at the second remote destination the second computing device receives that data in a wireless manner from a second base station and from the Internet.

44. A device comprising:
a receiver for receiving data associated with captured video images and audio data;
a display for displaying the data; and
a transmitter to transmit data to a computing device associated with a remote destination via at least one communication path of a plurality of communication paths, wherein the transmitter and the receiver are in a dongle operatively connected to the display.

45. A recordable computer medium comprising:
program instructions for authenticating a first user and once authenticated allowing the first user access to a software platform;
program instructions for receiving data comprising captured video and audio data displayed on a portable video monitor associated with a second user;
program instructions for displaying the captured audio and video data to a display associated with the first user; and
program instructions for permitting the first user or the second user to control a surveillance camera associated with the captured video and audio data.
